(19) United States
(12) Patent Application Publication
(10) Pub. No.: US 2006/0242679 A1
(43) Pub. Date: Oct. 26, 2006

(54) Remote monitoring and information system

(75) Inventors: James A. Hutchison III, Dover, DE (US); Carsie K. Denning JR., Coats, NC (US); Brian D. Bell, Durham, NC (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: GroupLynx, Wilmington, DE (US)

(21) Appl. No.: 11/398,219

(22) Filed: Apr. 5, 2006

Related U.S. Application Data
(60) Provisional application No. 60/668,247, filed on Apr. 5, 2005.

(51) Int. Cl. H04N 7/173

(52) U.S. Cl. 725/105

(57) ABSTRACT

A system and method provide information concerning a monitored location and live views of the location to a user at a location remote from the monitored location. The information may be information such as the layout of the monitored location. A network such as the Internet may be used to allow remote users live access to views from cameras set up in the monitored location. Users may control the cameras at the monitored location, and alarms at the monitored location may alert users when certain events occur at the monitored location.

### CROSS-REFERENCE TO RELATED APPLICATIONS

The present application claims the benefit of the filing date of U.S. Provisional Application No. 60/668,247, filed Apr. 5, 2005, the disclosure of which is hereby incorporated by reference herein.

### BACKGROUND OF THE INVENTION

Surveillance systems have been used in the past for the monitoring of a location, primarily for security reasons. Such systems are typically installed in office buildings, banks, stores, post offices, and schools. The monitoring of these locations is typically accomplished using a number of cameras located throughout the building on a closed-circuit television system. Using this system, an administrator typically has to be within the building to easily access a view of the premises from the cameras.

With the growing popularity of the Internet, surveillance systems have become increasingly accessible from remote locations. These systems are advantageous in that they allow a remote user, such as a building supervisor or director of security, to monitor the location even when they are in a remote location, such as their home. This is accomplished by connecting cameras at monitored locations to a server which is then accessible over the Internet using a remote computer. Using such a system, a user that is not present in the monitored location may access views from the cameras within the location by accessing the server through the Internet on his or her computer. The video supplied from these cameras may then be viewed on the computer display.

These Internet-based systems also have significant drawbacks. The remote user is typically presented with a list of cameras located in the monitored location that may be viewed, but if the remote user is not familiar with the monitored location, he or she may not be able to quickly access a view of a certain area of the monitored location. In addition, if a particular view from a camera presents a security or safety concern, the remote user may be unable to alert the authorities with detailed information as to the incident's whereabouts in the monitored location.

Another significant drawback is the lack of information available to the remote user concerning the monitored location. Typically, when a user located within the building views a condition that necessitates reference to, for example, the location's building plans, such as heating or plumbing schematics, the user has immediate access to such plans. A remote user viewing the monitored location has no access to such plans.

Therefore, there is a need for a remote monitoring system that allows the remote user to select a particular view of a monitored location based on a graphical layout of the location. There is also a need to present the remote user with more information concerning the monitored location, such as the plumbing and electrical systems of the monitored location.

### SUMMARY OF THE INVENTION

In one embodiment, the present invention comprises a remote monitoring system comprising a plurality of cameras at a monitored location; a computer for storing a map of the monitored location, the map including icons representing positions of the plurality of cameras of the monitored location; a display terminal remote from the monitored location; and a communication network for transmitting the map and video obtained by the plurality of cameras to the display terminal wherein a user can view the video from one of the plurality of cameras by selecting the icon representing the one camera from the map. The communication network may be adapted to transmit to the display terminal information concerning the monitored location other than the video and the map. The information may include a map of a plumbing system or an electrical system of the monitored location. The communication network may be adapted to be accessible wirelessly from a hand-held computer.

The monitoring system may also include at least one alarm adapted to notify the user if a predetermined condition occurs at the monitored location. The alarm may be an audible or visual signal at the remote location. The alarm may also comprise a signal sent to a user's cellular phone or personal digital assistant.

The monitoring system may provide a remote user with access to video from a plurality of cameras at a plurality of monitored locations. The user at the remote location may be able to control the plurality of cameras through the communication network. The user is preferably authenticated before being allowed access to view video from cameras.

The monitoring system may transmit a plurality of maps of the monitored location to the display terminal. The monitoring system may also provide a plurality of stored images or pictures of various parts of the monitored location to the remote terminal.

In another embodiment, the present invention comprises a method for remote surveillance of a monitored location, comprising the steps of connecting a plurality of cameras at the monitored location to a computer, storing information concerning the monitored location on the computer, providing a user at a remote location with the information concerning the monitored location, and allowing the user to view video from one of the plurality of cameras based on the information the user received concerning the monitored location. The user may also be provided with one or more maps of the monitored location. The cameras may be connected to the computer over a network.

In one embodiment, the method allows the user to control the plurality of cameras at the monitored location.

In another embodiment, the present invention comprises a recording medium for storing a computer program for causing a computer to perform a method of monitoring a remote location, the method comprising connecting the computer to a plurality of cameras at the monitored location over a computer network, accessing a site plan for the monitored location from the computer, displaying the site plan on a computer monitor associated with the computer, displaying a plurality of icons within the site plan on the computer monitor, each of the icons indicating a location of one of the plurality of cameras at the remote location, and displaying on the computer monitor live video from a selected one of the plurality of cameras in response to a user's selecting on the computer monitor of the icon corresponding to the selected camera.

In another embodiment, the present invention comprises a processor for monitoring a remote location, the processor being programmed to perform a method comprising the following steps: connecting the processor to a plurality of cameras at the monitored location over a computer network; accessing a site plan for the monitored location from the processor; displaying the site plan on a computer monitor associated with the processor; displaying a plurality of icons within the site plan on the computer monitor, each of the icons indicating a location of one of the plurality of cameras at the remote location; and displaying on the computer monitor live video from a selected one of the plurality of cameras in response to a user's selecting on the computer monitor of the icon corresponding to the selected camera.

### BRIEF DESCRIPTION OF THE DRAWINGS

FIG. 1 is a system diagram showing the various hardware elements used to construct a preferred embodiment of the invention.

FIG. 2 is a screenshot depicting a remote log-in screen.

FIG. 3 is a screenshot depicting various monitored areas.

FIG. 4 is a screenshot depicting a more detailed map with various particular monitored locations.

FIG. 5 is a screenshot depicting a floor layout of a monitored location.

FIG. 6 is a screenshot depicting a live view of the monitored location.

FIG. 7 is a screenshot depicting an alternative view of the floor layout of the monitored location.

FIG. 8 is a screenshot depicting the floor layout of an alternative location.

### DETAILED DESCRIPTION

The present invention is directed to providing access to a remote user to information and live views of a monitored location over a communications network such as the Internet.

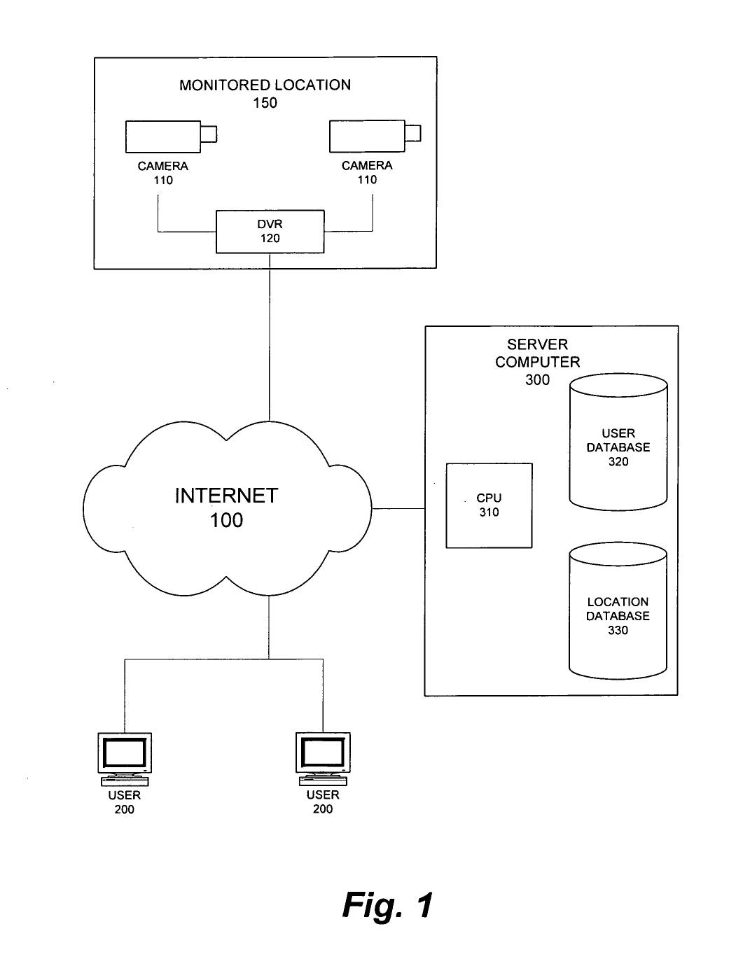

FIG. 1 depicts a preferred embodiment of the hardware used to implement the present system. Although FIG. 1 depicts a system used to monitor only one location, the system typically would be used to monitor a plurality of remote locations connected to one or more server computers through the Internet.

Remote users 200 use computers to access a server computer 300 through the Internet 100. The server computer stores in the user database 320 information concerning the authentication of the remote users to access certain information concerning monitored locations. The user database 320 may, for example, allow certain users to access information and camera views for only certain locations, while other users, such as the police, may be able to access all views of all locations.

The location database 330 of the server computer 300 stores information about each monitored location. This information preferably includes the geographical location of each monitored location 150, the location of each camera in the monitored locations, and various plans and layouts for each location. The layouts are preferably floor plans of each floor of each monitored building and outdoor area. The plans preferably contain information on the various gas, plumbing, electrical, and communications systems in each monitored location. The database may also store various still pictures from each of the plurality of cameras in the monitored locations 150 as a basis of comparison. These still photographs may be helpful to assist one who is unfamiliar with the area to assess how the area looks at another time, such as during the day.

The plurality of cameras may be connected to a server, such as an IP addressable server associated with a recorder, such as a digital video recorder (DVR) 120, at the monitored location which processes and transmits the video streams directly to the server computer 300 over the Internet. Alternatively, the cameras may be connected to a computer (not shown) at the monitored location which processes and transmits the video. In other embodiments, the cameras may be adapted to transmit the video streams directly over the Internet without an intermediary computer or recorder being necessary.

The server computer 300 preferably also contains a central processing unit (CPU) 310 for processing information received from the digital video recorder (DVR) 120 and requests from the various users 200.

The monitored location 150 preferably contains a plurality of cameras 110 located throughout the location, both indoors and outdoors, to provide live video to the digital video recorder (DVR) server 120. The server computer 300 allows the remote users 200 to view the video.

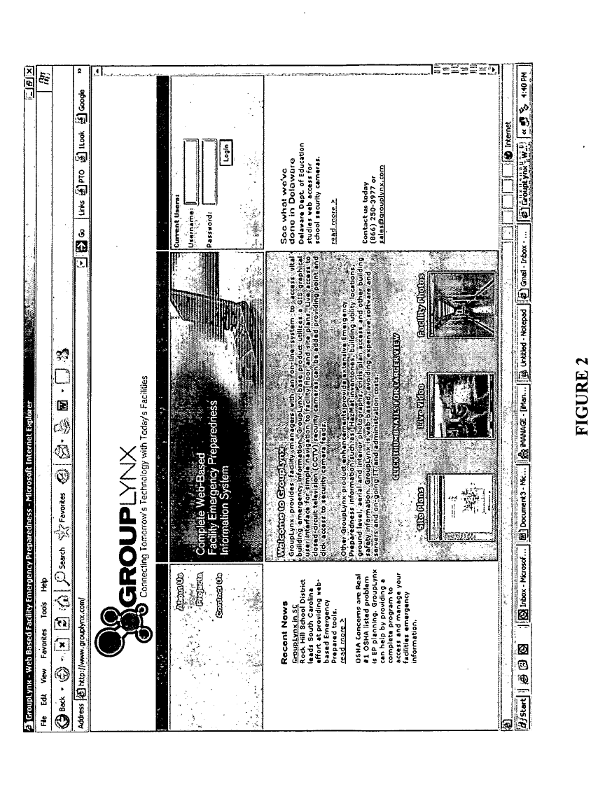

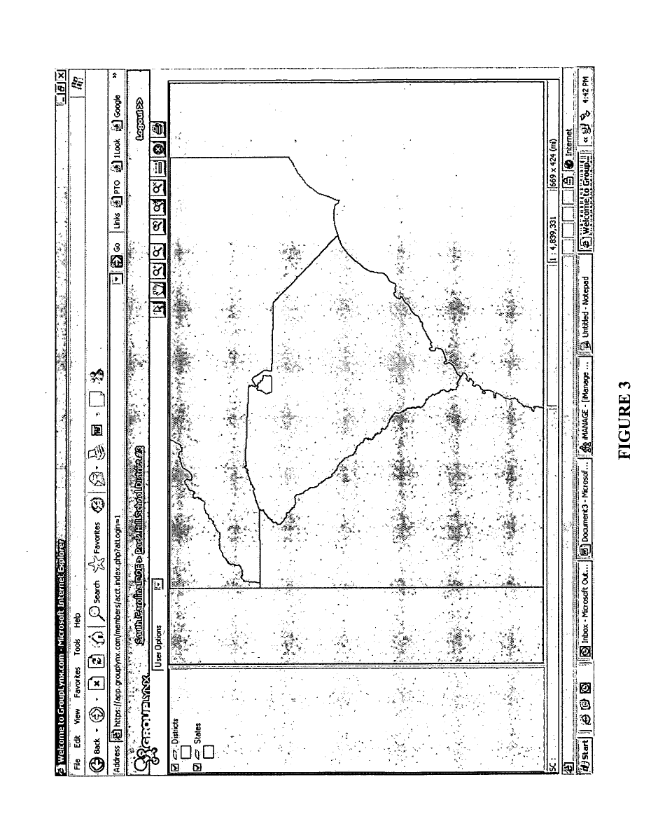

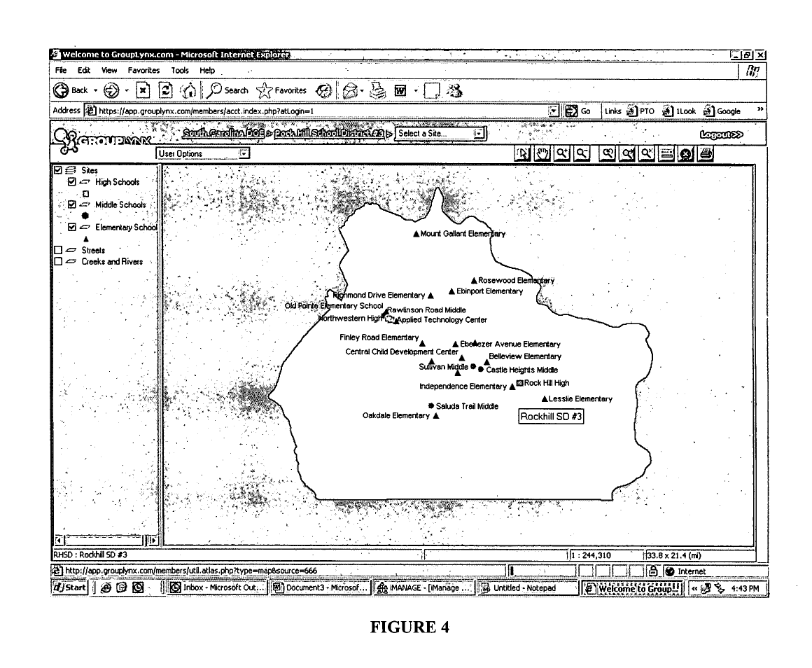

The screenshot of FIG. 2 shows the preferred embodiment for the remote user log-in screen. Authorized users are preferably given a username and password so that they may access the server computer 300 through any Internet-enabled computer. Once the user types in his or her username and password, he or she is given access to whatever areas they are authorized to view. For example, the screenshot of FIG. 3 shows a map of a state in which this user is authorized to view monitored locations. The user may select a certain district by clicking on that district with a mouse connected to his or her remote computer. FIG. 4 shows the various facilities within the selected district that this user is authorized to monitor. This particular user is shown an array of educational facilities, but a different user may be shown other facilities, such as stores in the area or various different office buildings.

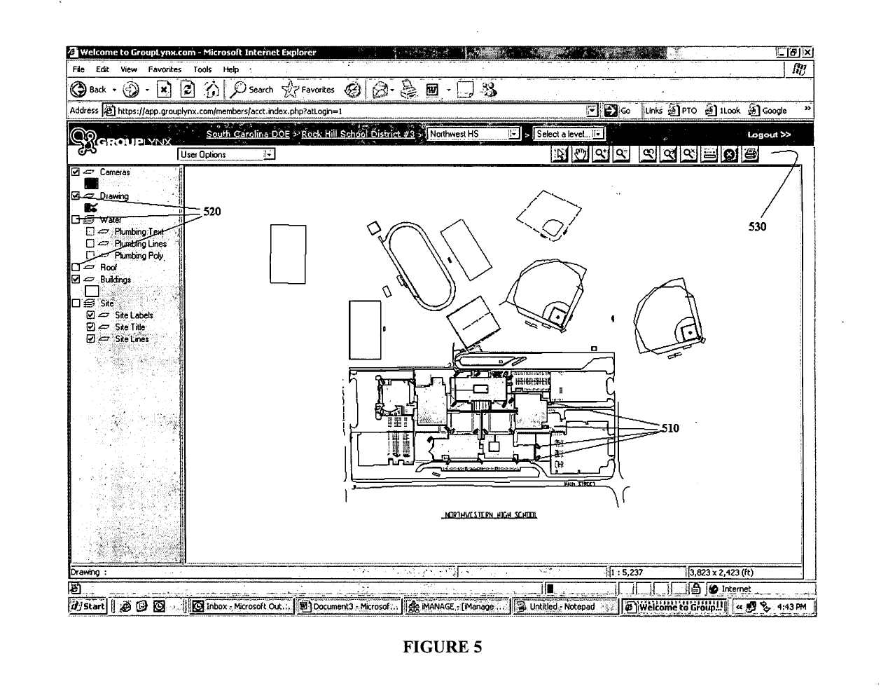

If the user were to select “Northwestern High School” on the map, he or she would be shown the overhead floor plan depicted in the screenshot of FIG. 5. The floor plan of the monitored facility preferably depicts a number of camera icons 510 to show the user exactly where each camera is located within the facility. As depicted here, certain floor plans may also show the outside areas of the monitored location. A monitored location may also have a plurality of cameras outdoors for monitoring the surrounding areas.

The present invention is particularly useful in cases in which individuals at remote locations are not familiar with the monitored location. For example, if the police receive a report that there is a hostage situation in the second floor lunchroom of a local high school, they will be able to navigate the floor layout of the high school on the web site and view the lunchroom immediately using the map of the second floor.

The screenshot of FIG. 5 also depicts various options for the user. The left side of, the screen shows checkboxes 520 for the various systems of the building, such as water. When a user checks the box next to one of these systems, an outline of the system becomes available on the map of the location. For example, if the user here were to click on the box next to “Water,” the various plumbing lines would be visible on the map, preferably in a color different from that of the floor plan itself.

The top of the screen shows a toolbar 530 which provides the user with various options, such as the ability to zoom in on the map of a location or print the map of a location.

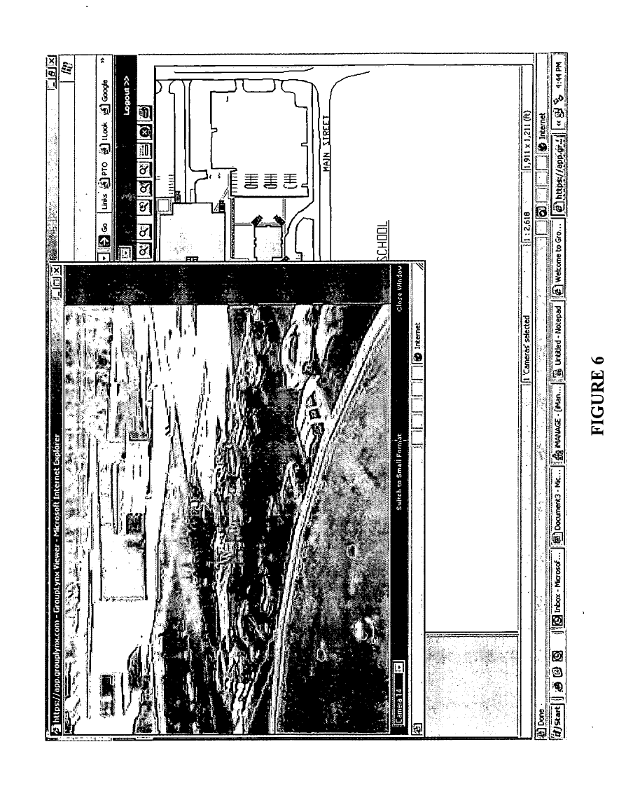

When a user clicks on one of the camera icons 510 depicted at a particular location on the floor layout, the user is provided with a large window showing a live view of the scene captured by the monitoring camera at that location, as shown in the screenshot of FIG. 6. The present invention allows the user to view a location based on the camera icon and the floor layout, so the user knows exactly what portion of the monitored location he or she is viewing through the camera. For example, if a user wants to view the west end of the parking lot location on Main Street, the user can see on the layout which camera or cameras are pointed at the parking lot, and can click the appropriate camera icon to view the parking lot.

Another embodiment of the present invention may allow the remote user to control the cameras using the web site. For example, when a user selects one of the camera icons 510, the user may be provided with a live view from the selected camera and a control panel to control the zoom and angle of the camera. The camera may rotate or move up and down in response to a user request.

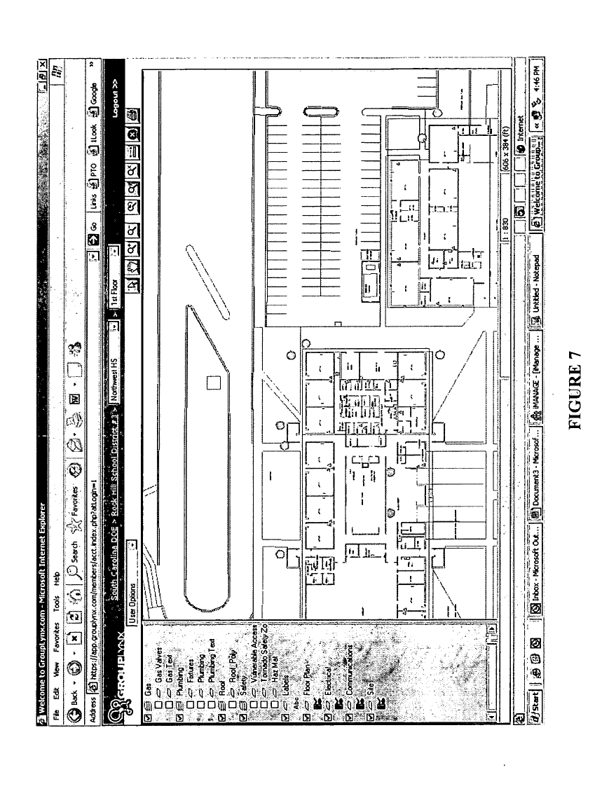

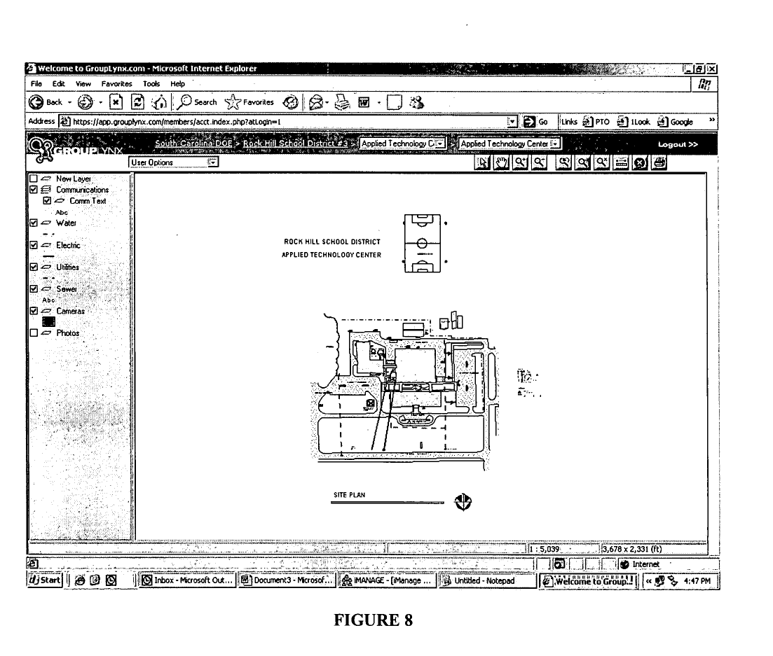

FIGS. 7 and 8 show screenshots of other monitored facilities. One skilled in the art would appreciate that various facilities may have specialized systems that may need to be monitored. For example, the heating and cooling systems of a nuclear power plant may have to be closely monitored for security concerns, so these systems may be depicted on the floor plans for these monitored locations.

The various maps used in the present invention may also include maps of the alarm systems of each monitored facility. The system may be adapted to show alarm conditions on the map. For example, in a prison, if a door is open that should be locked, there may appear a red icon on the map next to that door indicating that it is open. The remote user may then select the camera closest to the open door to view what is causing the door to stay open.

Alarm conditions displayed on the map may be useful in a variety of other applications. In a factory, for example, the monitoring system may be configured to display an alarm condition on the map to a remote user when a certain piece of machinery has malfunctioned. The remote user will not need to visit the site to determine who should be contacted to repair the malfunctioning machinery.

The present invention may be further adapted to send out alarm conditions by e-mail or phone call to alert a remote user that he or she should log on to the system to view the alarm condition.

While the present invention has been described with reference to a personal computer accessing a web site, it would be apparent to one skilled in the art that the present invention may also be used with hand-held computers, such as pocket PC's or personal digital assistants, and with wireless computing devices.

Although the present invention has been described in connection with a communication network operable over the Internet, one skilled in the art would recognize that such a network is not essential to the functionality of the invention. Thus, in one alternate embodiment, the present invention may comprise a storage medium incorporated in or connected to the remote terminal, the storage medium storing one or more maps of a monitored location. The storage medium may also store other information about the remote location, such as the location of utilities inside the remote location. The remote terminal may communicate directly with the various cameras in the monitored location using various means known in the art such that when a user at the remote terminal selects one of the camera locations on one of the maps stored in the storage medium, the live video stream from the camera at that location is retrieved directly from the camera and presented to the user on the remote terminal.

In one embodiment, each camera has transmitting means which transmit a signal directly to the remote terminal. In another embodiment, the plurality of cameras at the monitored location may be connected to a computer at the monitored location which includes a transmitter to transmit the signals collected from the plurality of cameras to the remote terminal. This configuration allows the present invention to operate without the need for a network.

In still another alternate embodiment, a computer at the monitored location stores maps and other information for that location with a direct link to a remote terminal.

It will be apparent to those of ordinary skill in the art that numerous alternatives and equivalents exist which do not depart from the invention set forth above. It is therefore to be understood that the present invention is not to be limited by the foregoing description, but only by the appended claims.

We claim:

1. A remote monitoring system, comprising:
a plurality of cameras at a monitored location;
a computer for storing a map of the monitored location, the map including icons representing positions of the plurality of cameras at the monitored location;
a display terminal remote from the monitored location and adapted to display the map; and
a communication network for transmitting video obtained by the plurality of cameras to the display terminal,
wherein a user can view the video from one of the plurality of cameras by selecting the icon representing the one camera from the map.

2. The monitoring system of claim 1, wherein the communication network is adapted to transmit to the display terminal information concerning the monitored location other than the video.

3. The monitoring system of claim 1 wherein the communication network is adapted to transmit the map to the display terminal.

4. The monitoring system of claim 2, wherein the information comprises a map of a plumbing system of the monitored location.

5. The monitoring system of claim 2, wherein the information comprises a map of an electrical system of the monitored location.

6. The monitoring system of claim 1, wherein the communication network is adapted to be accessible wirelessly from a hand-held computer.

7. The monitoring system of claim 1, further comprising at least one alarm adapted to notify the user if a predetermined condition occurs at the monitored location.

8. The monitoring system of claim 7, wherein the alarm is an audible alarm at the remote location.

9. The monitoring system of claim 1, wherein the communication network provides the user with access to video from a plurality of cameras at a plurality of monitored locations.

10. The monitoring system of claim 1, wherein the user is able to control the plurality of cameras through the communication network.

11. The monitoring system of claim 1, wherein the user is authenticated before being allowed access to view video from cameras.

12. The monitoring system of claim 1, wherein the communication network further transmits a plurality of maps of the monitored location to the display terminal.

13. The monitoring system of claim 1, wherein the communication network further transmits a plurality of stored pictures of the monitored location to the display terminal.

14. A method for remote surveillance of a monitored location, comprising:
connecting a plurality of cameras at the monitored location to a computer;
storing information concerning the monitored location on the computer;
providing a user at a remote location with the information concerning the monitored location; and
allowing the user to view video from one of the plurality of cameras based on the information the user received concerning the monitored location.

15. The method of claim 14, wherein the step of providing the user with the information concerning the monitored location comprises providing the user with one or more maps of the monitored location.

16. The method of claim 14, wherein the step of connecting a plurality of cameras at the monitored location to a computer further comprises connecting the plurality of cameras to the computer over a network.

17. The method of claim 14, further comprising allowing the user to control the plurality of cameras from the remote location.

18. A recording medium for storing a computer program for causing a computer to perform a method of monitoring a remote location, the method comprising:
connecting the computer to a plurality of cameras at the monitored location over a computer network;
accessing a site plan for the monitored location from the computer;
displaying the site plan on a computer monitor associated with the computer;
displaying a plurality of icons within the site plan on the computer monitor, each of the icons indicating a location of one of the plurality of cameras at the remote location; and
displaying on the computer monitor live video from a selected one of the plurality of cameras in response to a user's selecting on the computer monitor of the icon corresponding to the selected camera.

19. A processor for monitoring a remote location, the processor being programmed to perform a method, the method comprising the following steps:
connecting the processor to a plurality of cameras at the monitored location over a computer network;
accessing a site plan for the monitored location from the processor;
displaying the site plan on a computer monitor associated with the processor;
displaying a plurality of icons within the site plan on the computer monitor, each of the icons indicating a location of one of the plurality of cameras at the remote location; and
displaying on the computer monitor live video from a selected one of the plurality of cameras in response to a user's selecting on the computer monitor of the icon corresponding to the selected camera.
